(19) United States
(12) Patent Application Publication
(10) Pub. No.: US 2003/0211212 A1
(43) Pub. Date: Nov. 13, 2003

(54) Method and apparatus for providing heat exchange with continuous stream of containers

(76) Inventors: Larry P. Belongia, Oconto, WI (US); George Catsuros, Green Bay, WI (US); Lawrence D. Clay, Green Bay, WI (US); Gary J. Demerath, De Pere, WI (US); Todd Olson, Green Bay, WI (US); John Slatinsky, Oconomowoc, WI (US)

Correspondence Address: THADDIUS J. CARVIS, 102 NORTH KING STREET, LEESBURG, VA, 20176, US

(21) Appl. No.: 10/444,247

(22) Filed: May 23, 2003

Related U.S. Application Data
(62) Division of application No. 09/217,322, filed on Dec. 21, 1998, now abandoned.

(51) Int. Cl. A23B 4/00

(52) U.S. Cl. 426/407

(57) ABSTRACT

Containers, such as those for food, can be heated or cooled efficiently and in a small space as they are continuously conveyed from a filling station to a packaging station. A cabinet encloses a carriage that holds the container for heating or cooling. Containers are fed into and held in flights by a plurality of dividers spaced around the periphery of the carriage. Intermittent rotation of the carriage permits discharge of a flight of processed containers and feed of containers in need of processing. Heat transfer fluid is circulated through the cabinet and contacted with the containers for the complete time it takes for the carriage to complete a full revolution. The apparatus operates in a semi-continuous manner, but with the use of suitable collection areas in front of and behind the apparatus, the process becomes essentially continuous.

### TECHNICAL FIELD

The invention relates to an improved method and apparatus for providing heat exchange with continuous stream of containers. In particular, the invention enables cooling or heating continuously-conveyed containers at a high rate and within a relatively small space.

Containers, especially food containers, are often in need of heating or cooling for any of a variety of reasons. Heating must be done effectively to secure its benefits and will preferably be done continuously without occupying excessive floor space. Autoclaves are, however, usually not continuous and long heating tunnels require large amounts of floor space. Cooling should likewise be done effectively, continuously and in a small floor area. Again, however, typical cooling arrangements require large cooling tunnels or rooms.

There is a need for a method and apparatus that will facilitate either heating or cooling containers effectively, continuously and in a small floor area.

### BACKGROUND ART

Many packaged food products require either cooling or heating after packaging. Some require both.

Among the food products that require cooling are those that are packaged while hot. In many cases these products must be cooled down to prevent degradation of their properties. For example, some cheese products are prepared hot and fed into pressurized dispenser containers at relatively high temperatures. Unless these hot products are cooled sufficiently before grouping into packing cases or into palletized loads, the heat will be dissipated so slowly that the product can degrade to the point that its quality becomes unacceptable or the dispenser container becomes inoperable.

The most widely used heating devices are known as retorts. Apparatus of this type is costly and noncontinuous. Cooling devices are typically cooling tunnels and rooms. Both are bulky and the latter is not effective for the purposes mentioned just above. Despite the wide variety of heating and cooling devices and procedures taught by the art, there remains a need for improvements that enable effective, efficient cooling within a small area of plant space.

### DISCLOSURE OF INVENTION

It is an object of the invention to provide a method and apparatus that can facilitate either heating or cooling containers effectively, continuously and in a small floor area.

It is an object of the invention to provide a heat exchange apparatus that can hold a large number of containers fed semi-continuously from a conveyor operating at a high linear speed.

It is a more specific object of the invention to provide a method and an apparatus for cooling cans with air while requiring only a small space.

It is another specific object of the invention to provide a method and an apparatus for cooling cans with air as a continuous part of a filling and packaging line.

These and other objects are realized by the present invention, which provides both an improved method and an apparatus for heating and cooling containers.

In one aspect of the invention, the method comprises: discharging a discharge group of containers from one of a plurality of flights on a container carriage that is rotatable about a horizontal axis; transferring a feed group of containers into the flight from which the discharge group is discharged; rotating said carriage; and contacting the containers held on said container carriage with a flow of heat exchange fluid.

In another of its aspects, the invention provides an apparatus for effecting heat exchange with filled containers, comprising: a carriage rotatable on a horizontal axis, said carriage including a foraminous cylindrical member and a plurality of dividers spaced around the periphery of said foraminous cylindrical member and extending radially from the cylindrical member, the space between said dividers forming flights adapted to hold containers; a cabinet enclosing said carriage; conveyor means aligned with the horizontal axis for transferring containers into and from flights defined by adjacent dividers; drive means for rotating said carriage about said horizontal axis in increments equal to the distance between adjacent dividers; and means for providing a flow of heat exchange fluid through said cabinet for contacting the containers held on said container carriage.

Other preferred aspects of the invention will be detailed below.

### BRIEF DESCRIPTION OF THE DRAWINGS

The invention will be better understood and its advantages will become more apparent from the following detailed description, especially when read in light of the accompanying drawings, wherein:

FIG. 1 is a perspective view of the overall arrangement of the heat-exchange apparatus of the invention in a preferred configuration for cooling containers by contact with air;

FIGS. 2A through 2F are schematic views from the top with detail removed to show the sequence of loading and unloading containers into the apparatus of FIG. 1;

FIG. 3 is a rear elevation view of the apparatus shown in FIG. 1;

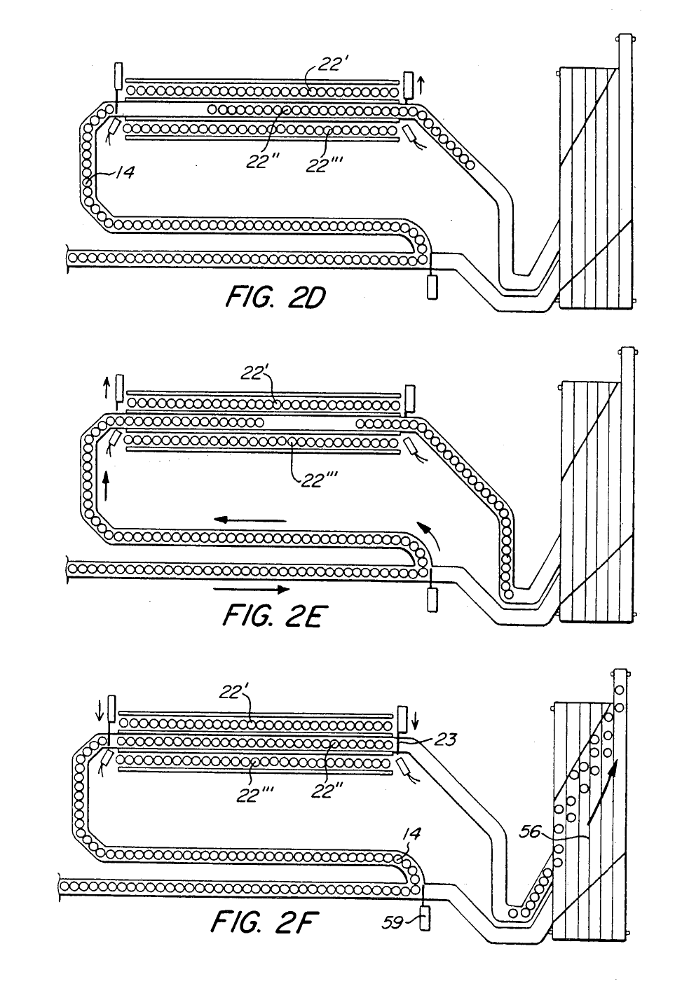

FIG. 4 is a front elevation view of the apparatus shown in FIG. 1, again partially broken away, the view revealing containers being fed into the apparatus;

FIG. 5 is a broken away view revealing a portion of the apparatus shown in FIG. 3;

FIG. 6 is a perspective view of the apparatus of FIG. 1, with the cabinet shown in dotted lines to reveal details of the interior and the airflow pattern of this preferred embodiment; and

FIG. 7 is a side elevation view of the apparatus shown in FIG. 1, having a portion of the exterior cabinet broken away to better reveal details of operation.

### INDUSTRIAL APPLICABILITY

The invention will be described below, first with regard to a preferred application wherein an apparatus is configured to cool containers, typically of food. Later, the description will point out features important where the objective is to heat containers, especially with the use of steam.

The invention has applicability to all types of containers, including those in the form of cans, bottles, jars and other configurations. The invention is not limited to containers of any particular size or material of construction, but the drawings illustrate the containers as 8-ounce pressurized cans suitable for dispensing a cheese spread through a nozzle. Unless emulsified products of this type are properly cooled prior to packing in cases and palletizing, the properties of the cheese spread can degrade and the dispensers can clog.

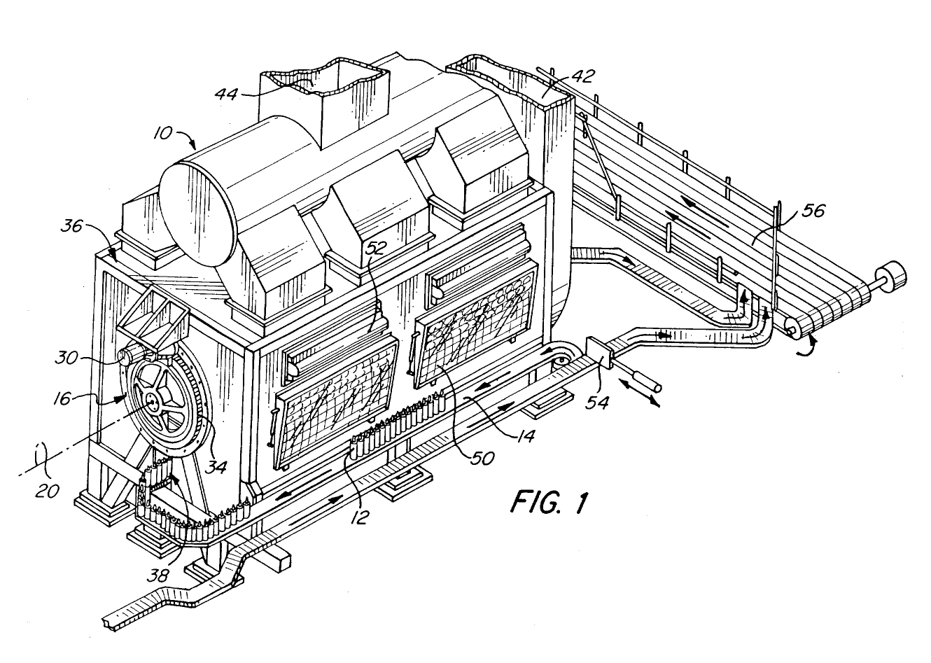

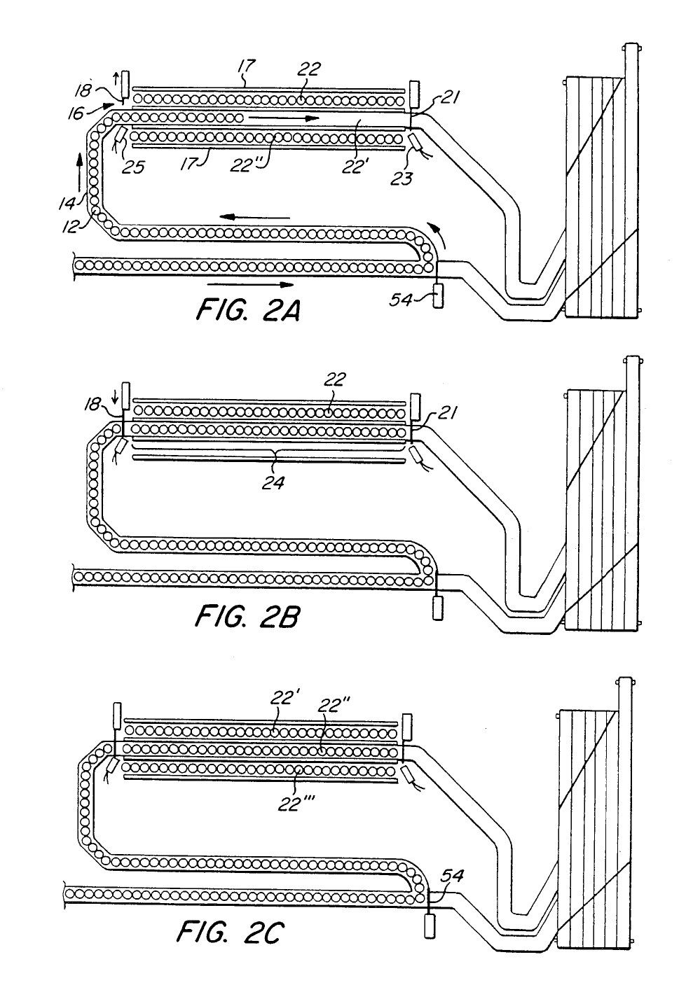

FIG. 1 shows the overall arrangement of the heat-exchange apparatus of the invention in a perspective view. It is configured to cool containers by contacting them with a flow of air. This Figure and FIGS. 2A through 2B can be viewed to obtain an easily understood overview of the method and apparatus of the invention.

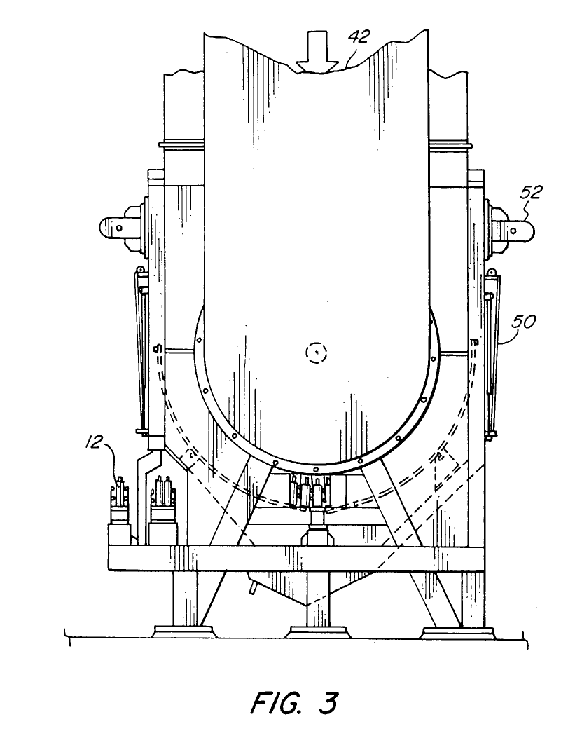

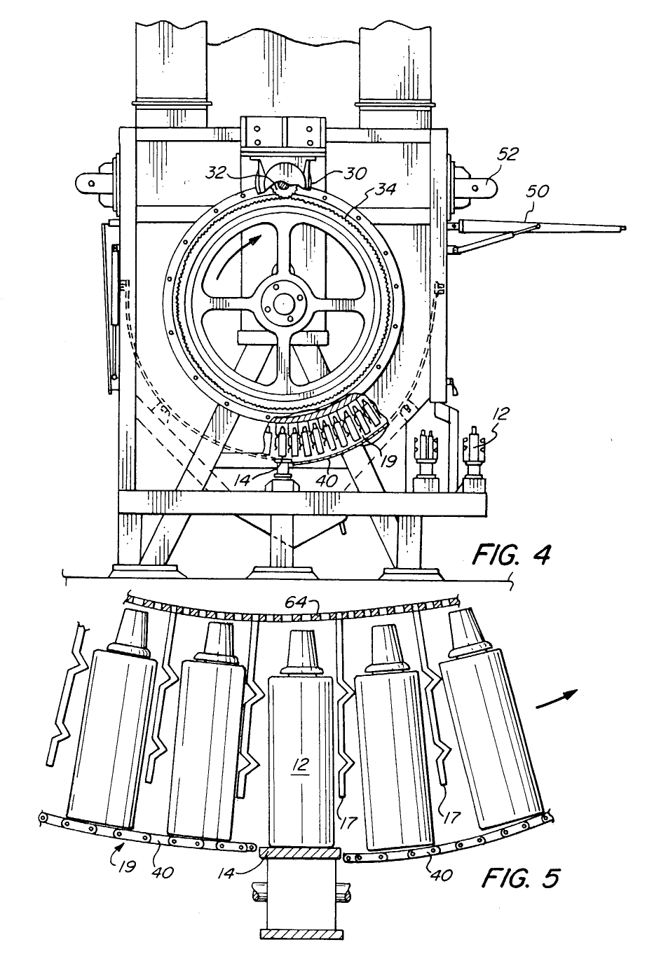

Cooling apparatus 10 is shown in FIG. 1 to be stopped for discharging a group of cooled containers and to receive a group of containers in need of cooling. Containers 12 are fed along a conveyor 14 toward the feed end 16 (front) of the apparatus 10. The conveyor 14 is illustrated as a single unit, but is preferably formed in segments to permit direction changes as necessary for a particular work space. A plurality of uniformly-spaced dividers 17 define flights which are dimensioned to hold rows of containers. (See, for example, FIGS. 2A and 5) A gate 18 at the feed end is capable of blocking or permitting the entry of containers into apparatus 10 for cooling by a flow of cooling air. As will be explained later in greater detail, with reference to FIG. 4, a plurality of flights for holding groups of containers are provided around the periphery of a container carriage 19 that is rotatable about a horizontal axis 20. The drawings illustrate rotation as clockwise, viewed from the feed or front end 16 of the apparatus. Within the apparatus, the conveyor 14 moves in a direction parallel to the axis of rotation 20 of the carriage 19 and is aligned with dividers 17.

FIGS. 2A through 2F illustrate the feed and discharge of containers by schematic representation of the three lower-most flights on the carriage 19 as viewed from above. Carriage movement is from the bottom of the drawing toward the top. FIG. 2A shows the gate 18 in open position and gate 21 in the closed position to permit the containers to fill an empty flight 22′ in the cooling apparatus 10. The feed group can be of any desired size, but in the case of a specific application wherein 8-ounce containers are utilized, from about 50 to about 100 containers form groups of convenient size. It is desired that the feed group be of a predetermined size, preferably to fill an entire flight running the length of the apparatus and to permit suitable control.

FIG. 2B shows gate 18 closing responsive to a control means, including sensor 25, indicating that the flight 22′ is filled to the desired extent. A control means for gate 21 includes a sensor 23. FIG. 2B shows gate 21 remaining in the closed position. Photoelectric sensors and limit switches are suitable for sensing the location of the flights and containers and generating signals to effect the desired control action. Flight 22 has been filled in the previous step, and flight 22″ represents a filled flight that has completed one complete revolution of the carriage 19 about axis 20.

In FIG. 2C, both gates 18 and 21 are in the closed position to prevent feed or discharge of containers as the carriage 19 is indexed by rotating the carriage 19 to bring flight 22″ into alignment with the conveyor for discharge of cooled containers to the right (as shown in FIG. 2D) and feed of hot containers from the left right (as shown in FIG. 2E). FIG. 2F shows the completion of the discharge/feed cycle, again with both gates 18 and 21 closed, just prior to rotation of the carriage as in FIG. 2C.

With this general description of the operation of the apparatus in the cooling mode, attention will now be focused on details of the preferred form of the apparatus as shown in the accompanying drawings. FIG. 1 shows the apparatus 10 to include the a drive motor 30 which rotates the carriage 19 about axis 20 by means of engagement of geared drive wheel 32 (See FIG. 4) with driven geared wheel 34. Wheel 34 is attached to carriage 19 such that the carriage moves with wheel 34. The operation of drive motor 30 is controlled by sensors, such as a photoelectric sensor or limit switch mounted inside the cabinet 36, e.g., at a point near entrance 38. In this manner, the drive motor will rotate the carriage until a flight just filled is moved off of the conveyor and a flight with completely cooled containers is brought to the conveyor as previously described.

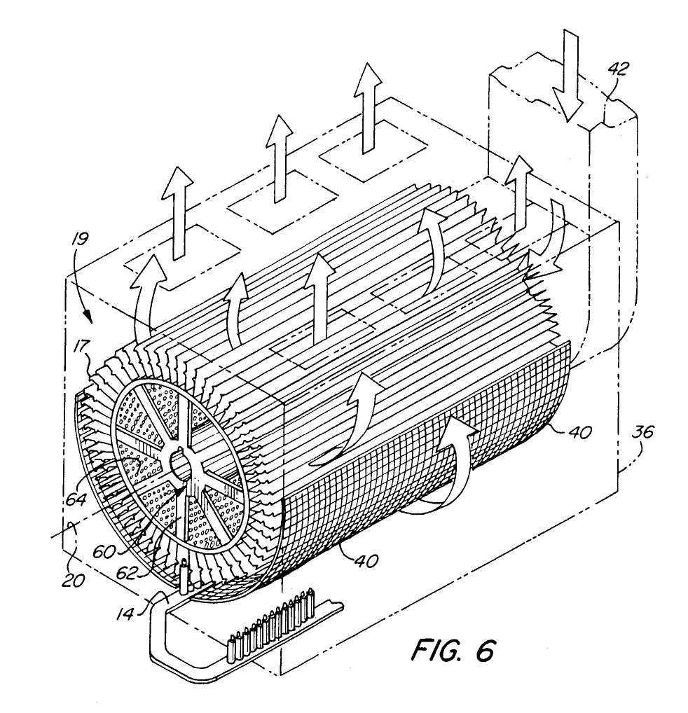

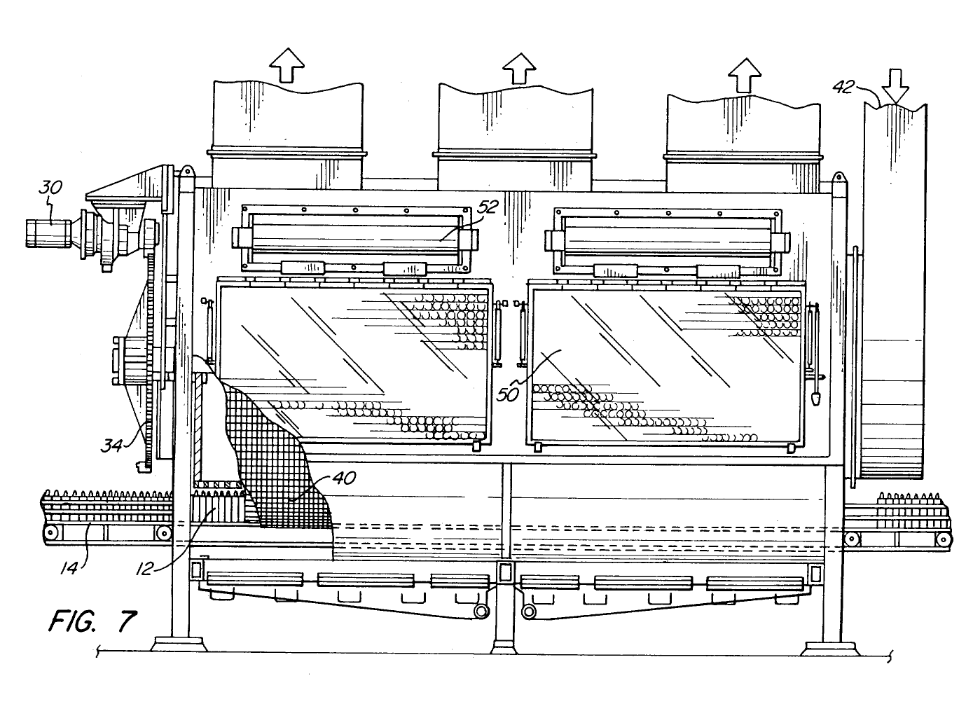

FIGS. 4 and 5 show the lower portion of the carriage 19 to be surrounded with a fence 40, typically of a suitable mesh, except in the area of conveyor 14. The fence 40 maintains the containers 12 between dividers 17 for orderly containment during a full revolution of the carriage. FIGS. 6 and 7 most clearly the construction of the fence 40, which is needed only at the lower half of the carriage because gravity will keep the containers in place at the top. FIG. 5 shows a preferred arrangement where the fence 40 is slightly higher than the conveyor on the side where the containers held in a flight approach the conveyor (to the left in this exit end view). It also shows the fence 40 to be slightly lower than the conveyor on the other side. In this manner, the transfer of the containers onto and off of the conveyor is assisted by gravity and sliding friction between the containers and the supporting surfaces is reduced.

Air is introduced at one end of the apparatus through duct 42 and exited through duct 44. FIG. 6 illustrates the flow of air within the cabinet 36 (shown here in dashed lines). The air enters through duct 42 and flows through a central cavity within the carriage and then outwardly past the containers held in the individual flights prior to exit through ductwork at the top. The air can be any temperature below the desired final cooling temperature of the containers, but will typically be within the range of from about 10 to 20° C. In the noted example of cooling hot, pressurized cheese containers, ambient outside air can be employed in most cases.

While the apparatus is simple in construction and reliable in operation, doors 50 are provided in the cabinet 36 to permit viewing of the contents through glass panels and access to the interior when in the open position as shown in FIG. 4. Viewing the contents of the cabinet is facilitated by lighting units 52.

Provision is preferably made for container collection due to processing anomalies at either the feed or discharge end of the apparatus. At the feed end, conveyor 14 is provided with a gate 54 that is opened or closed responsive to a control signal indicating that either the apparatus is ready to accept more containers or that they should be diverted. In the case of diversion, the gate 54 is opened and the containers are permitted to spill out into collection area 56. When an anomaly prevents cooled containers from moving downstream of the exit end of the apparatus, they are again permitted to collect in are 56.

The construction of carriage 19, as to its important components, can be seen from the figures to include a central support structure that includes hubs 60 at the both ends and radial spokes 62 extending from the hubs. The spokes support a foraminous cylindrical member 64. The dividers 17 can be affixed directly to the foraminous member 64 or to an auxiliary support if that is desired. The dividers are seen to project radially from the central axis 20.

In the case where it is desired to employ the apparatus for heating, it is preferred that the cabinet include an insulating material of sufficient thickness and effectiveness to decrease heat loss from the apparatus. It may also be useful to provide seals around the doors 50 and lock means at entrance and exit openings to control the loss of heat transfer medium. For heating, hot air or steam will be the heat transfer media of choice.

The above description is intended to enable the person skilled in the art to practice the invention, It is not intended to detail all of the possible modifications and variations, which will become apparent to the skilled worker upon reading the description. It is intended, however, that all such modifications and variations be included within the scope of the invention which is defined by the following claims. The claims are meant to cover the indicated elements and steps in any arrangement or sequence which is effective to meet the objectives intended for the invention, unless the context specifically indicates the contrary.

1. A process for effecting heat exchange with a filled container, comprising:
discharging a discharge group of containers from one of a plurality of flights on a container carriage that is rotatable about a horizontal axis;
transferring a feed group of containers into the flight from which the discharge group is discharged;
rotating said carriage; and
contacting the containers held on said container carriage with a flow of heat exchange fluid.

2. A process according to claim 1, wherein the discharge group is discharged, and the feed group is transferred, by conveyor means moving in a direction parallel to the axis of rotation of said carriage.

3. A process according to claim 1, wherein following transfer of said feed group into said flight, said carriage is rotated sufficiently to index each flight into position for discharge and feed, with the containers being held in the apparatus for an entire revolution of said carriage during which the containers are contacted with a flow of heat transfer fluid.

4. A process according to claim 1, wherein the heat transfer fluid comprises air having a temperature lower than the temperature of the containers in the feed group.

5. A process according to claim 1, wherein the heat transfer fluid comprises a gas having a temperature higher than the temperature of the containers in the feed group.

6. A process according to claim 1, wherein said containers are held in place on a lower portion of said carriage by an exterior fence during rotation through a complete revolution of said carriage.

7. A process according to claim 1, wherein said carriage is enclosed by a cabinet.

10. An apparatus for effecting heat exchange with filled containers, comprising:
a carriage rotatable on a horizontal axis, said carriage including a cylindrical member and a plurality of dividers spaced around the periphery of said cylindrical member and extending radially from the cylindrical member, the space between said dividers forming flights adapted to hold containers;
a cabinet enclosing said carriage;
conveyor means aligned with the horizontal axis for transferring containers into and from flights defined by adjacent dividers;
drive means for rotating said carriage about said horizontal axis in increments equal to the distance between adjacent dividers; and
means for providing a flow of heat exchange fluid through said cabinet for contacting the containers held on said container carriage.

11. An apparatus according to claim 10, wherein the cylindrical member comprised in the carriage is foraminous.

12. An apparatus according to claim 11, wherein ducting is provided to direct the heat exchange fluid through the interior of the foraminous cylindrical member and radially outward therefrom.

13. An apparatus according to claim 10, wherein a fence is spaced from the carriage around a lower portion of said carriage to maintain the containers in place during rotation through a complete revolution of said carriage.

14. An apparatus according to claim 10, which further includes collection areas in front of and behind the apparatus.

15. An apparatus according to claim 10, which further includes control means associated with gates to sense the location of the carriage and the containers on the conveyor and control the gates to permit a flight filled with processed containers to be discharged and containers in need of processing to be fed into the flight.

16. An apparatus according to claim 15, which further includes a fence surrounding at least a bottom portion of the carriage, positioned to maintain the containers within the flights during rotation of the carriage.

17. An apparatus for effecting heat exchange with filled containers, comprising:
a carriage rotatable on a horizontal axis, said carriage including a foraminous cylindrical member and a plurality of dividers spaced around the periphery of said foraminous cylindrical member and extending radially from the cylindrical member, the space between said dividers forming flights adapted to hold containers;
a fence, spaced from the carriage around a lower portion of said carriage to maintain the containers in place during rotation through a complete revolution of said carriage;
a cabinet enclosing said carriage;
conveyor means aligned with the horizontal axis for transferring containers into and from flights defined by adjacent dividers;
drive means for rotating said carriage about said horizontal axis in increments equal to the distance between adjacent dividers; and
means including ductwork for providing a flow of heat exchange fluid through said cabinet for contacting the containers held on said container carriage.

18. An apparatus according to claim 17, which further includes collection areas in front of and behind the apparatus.

19. An apparatus according to claim 17, which further includes control means associated with gates to sense the location of the carriage and the containers on the conveyor and control the gates to permit a flight filled with processed containers to be discharged and containers in need of processing to be fed into the flight.

20. An apparatus for effecting heat exchange with filled containers, comprising:
a carriage rotatable on a horizontal axis, said carriage including a foraminous cylindrical member and a plurality of dividers spaced around the periphery of said foraminous cylindrical member and extending radially from the cylindrical member, the space between said dividers forming flights adapted to hold containers;
a fence, spaced from the carriage around a lower portion of said carriage to maintain the containers in place during rotation through a complete revolution of said carriage;
a cabinet enclosing said carriage;
conveyor means aligned with the horizontal axis for transferring containers into and from flights defined by adjacent dividers;
collection areas in front of and behind the apparatus;
drive means for rotating said carriage about said horizontal axis in increments equal to the distance between adjacent dividers;
means including ductwork for providing a flow of heat exchange fluid through said cabinet for contacting the containers held on said container carriage; and
control means associated with gates to sense the location of the carriage and the containers on the conveyor and control the gates to permit a flight filled with processed containers to be discharged and containers in need of processing to be fed into the flight.
